(19) United States
(12) Patent Application Publication
(10) Pub. No.: US 2024/0272000 A1
(43) Pub. Date: Aug. 15, 2024

(54) WAVELENGTH-RESOLVED PHOTONIC LANTERN WAVEFRONT SENSOR

(71) Applicant: University of Central Florida Research Foundation, Inc., Orlando, FL (US)

(72) Inventors: Stephen Eikenberry, Orlando, FL (US); Rodrigo Amezcua-Correa, Orlando, FL (US); Daniel Cruz-Delgado, Orlando, FL (US); Stephanos Yerolatsitis, Orlando, FL (US); Matthew Cooper, Orlando, FL (US); Miguel A. Bandres, Orlando, FL (US)

(21) Appl. No.: 18/441,765

(22) Filed: Feb. 14, 2024

Related U.S. Application Data
(60) Provisional application No. 63/445,435, filed on Feb. 14, 2023.

(51) Int. Cl. G01J 3/28; G01J 3/02; G01J 3/14

(52) U.S. Cl. CPC G01J 3/2823; G01J 3/0218; G01J 3/14

(57) ABSTRACT

A sensor may include one or more photonic lanterns, each including a waveguide structure with a single input waveguide at an input end and two or more output waveguides at an output end, where the two or more output waveguides of each of the one or more photonic lanterns are optically decoupled. A distribution of intensities of light exiting two or more output waveguides of each of the one or more photonic lanterns may correspond to a modal decomposition of input light coupled into the input waveguide of the corresponding one of the one or more photonic lanterns. The sensor may further include one or more spectrometers coupled to the two or more output waveguides of the one or more photonic lanterns to provide a wavelength-resolved modal decomposition of the input light.

### CROSS-REFERENCE TO RELATED APPLICATION

The present application claims the benefit under 35 U.S.C. § 119(e) of U.S. Provisional Application Ser. No. 63/445,435, filed Feb. 14, 2023, entitled WAVELENGTH-RESOLVED PHOTONIC LANTERN WAVEFRONT SENSOR, naming Stephen Eikenberry, Rodrigo Amezcua-Correa, Daniel Cruz-Delgado, Stephanos Yerolatsitis, Matthew Cooper, and Miguel A. Bandres as inventors, which is incorporated herein by reference in the entirety.

### BACKGROUND

A photonic lantern is a monolithic optical fiber device that accepts a wavefront/image and transforms the resulting multimode beam into an array of distinct single mode beams at high optical efficiency. By reciprocity, light conversion from single mode to multimode beams can also be done in reverse. In general, a photonic lantern is a waveguiding device having multiple uncoupled waveguides (e.g., optical fibers) at one end that are adiabatically merged into a single waveguide at another end. For example, a collection of single-mode (SM) waveguides may be interfaced to a multimode waveguide through a physical transition (see e.g., S. G. Leon-Saval, T. A. Birks, J. Bland-Hawthorn, and M. Englund, “Single-mode performance in multimode fibre devices,” in Optical Fiber Communication Conference and Exposition and The National Fiber Optic Engineers Conference, Technical Digest (CD) (Optica Publishing Group, 2005), paper PDP25; and T. A. Birks, I. Gris-Sanchez, S. Yerolatsitis, S. G. Leon-Saval, and R. R. Thomson, “The photonic lantern,” Adv. Opt. Photon. 7, 107-167 (2015); both of which are incorporated herein by reference in their entireties). The second law of thermodynamics allows lossless coupling from an arbitrarily excited multimode fiber system into single mode channels, provided that the two systems have the same number of degrees of freedom. In this regard, light can adiabatically transition from one base set of modes to another, at very high optical efficiency.

While photonic lanterns are inherently broadband devices, their modal composition is very much wavelength sensitive. In fact, the number of waveguide modes scales as 1/λ², where Δ is the wavelength of the light. Thus, simply feeding broadband light into a photonic lantern will naturally result in degeneracy of measured decomposed modes over broad ranges of wavelength. As a result, photonic lanterns used for modal decomposition applications such as, but not limited to, wavefront sensing applications, are typically coupled with a bandpass filter to filter incident light. However, while this methodology reduces the modal uncertainty as the bandpass decreases, it also reduces the number of photons available for measurement and thus the ultimate signal-to-noise. This results in the need for a compromise between conflicting demands for signal throughput and wavefront resolution. Ultimately, this produces a performance limit, as otherwise valid photon signals are rejected to preserve resolution. This is a key driver in many applications, where instability versus time drives the need for high signal-to-noise in short times. There is therefore a need to develop systems and methods to cure the above deficiencies.

### SUMMARY

In embodiments, the techniques described herein relate to a sensor including one or more photonic lanterns, each of the one or more photonic lanterns including a waveguide structure with an input waveguide at an input end and two or more output waveguides at an output end, where the two or more output waveguides of each of the one or more photonic lanterns are optically decoupled, where a distribution of intensities of light exiting the two or more output waveguides of each of the one or more photonic lanterns corresponds to a modal decomposition of input light coupled into the input waveguide of a corresponding one of the one or more photonic lanterns; and one or more spectrometers coupled to the two or more output waveguides of the one or more photonic lanterns to provide a wavelength-resolved modal decomposition of the input light.

In embodiments, the techniques described herein relate to a sensor, further including a controller communicatively coupled to the one or more spectrometers, the controller including one or more processors configured to execute program instructions causing the one or more processors to determine wavelength-resolved measurements of at least one of an amplitude or a phase associated with modes of the input light.

In embodiments, the techniques described herein relate to a sensor, where the one or more photonic lanterns include two photonic lanterns, where base modes associated with the modal decomposition of each of the two photonic lanterns are different, where the sensor further includes a beamsplitter to receive the input light and direct portions of the input light to the input waveguides of the two photonic lanterns.

In embodiments, the techniques described herein relate to a sensor, where the one or more photonic lanterns include a single photonic lantern.

In embodiments, the techniques described herein relate to a sensor, further including a controller communicatively coupled to the one or more spectrometers, the controller including one or more processors configured to execute program instructions causing the one or more processors to determine wavelength-resolved measurements of at least one of amplitudes or phases associated with modes of the input light.

In embodiments, the techniques described herein relate to a sensor, where determining the wavelength-resolved measurements of at least one of the amplitudes and the phases associated with the modes of the input light includes determining the wavelength-resolved measurements of at least one of the amplitudes and the phases associated with the modes of the input light using a machine learning algorithm.

In embodiments, the techniques described herein relate to a sensor, where the machine learning algorithm is trained on wavelength-resolved modal decompositions associated with a plurality of configurations of the input light with known values of at least one of amplitudes or phases of associated modes.

In embodiments, the techniques described herein relate to a sensor, where the one or more spectrometers include a single spectrometer with a single two-dimensional detector, where the sensor further includes two or more optical fibers coupled with the two or more output waveguides of the one or more photonic lanterns, where output ends of the two or more optical fibers are arranged in a linear distribution along a first direction at an input of the single spectrometer, where the single spectrometer includes a dispersive element to disperse the light from the two or more optical fibers along a second direction orthogonal to the first direction.

In embodiments, the techniques described herein relate to a sensor, where the waveguide structure of at least one of the one or more photonic lanterns includes a fiber waveguide structure.

In embodiments, the techniques described herein relate to an imaging system including an imaging sub-system including optics configured to image one or more objects onto a field plane; a sensor at the field plane including one or more photonic lanterns, each of the one or more photonic lanterns including a waveguide structure with an input waveguide at an input end and two or more output waveguides at an output end, where the two or more output waveguides of each of the one or more photonic lanterns are optically decoupled, where a distribution of intensities of light exiting the two or more output waveguides of each of the one or more photonic lanterns corresponds to a modal decomposition of input light coupled into the input waveguide of a corresponding one of the one or more photonic lanterns; and one or more spectrometers coupled to the two or more output waveguides of the one or more photonic lanterns to provide a wavelength-resolved modal decomposition of the input light; and a controller communicatively coupled to the one or more spectrometers, the controller including one or more processors configured to execute program instructions causing the one or more processors to receive the wavelength-resolved modal decomposition of the input light; and generate an image of the one or more objects based on the wavelength-resolved modal decomposition of the input light.

In embodiments, the techniques described herein relate to an imaging system, where generating the image of the one or more objects based on the wavelength-resolved modal decomposition of the input light includes solving for phase variations for a particular timeframe; constructing a turbulence-corrected image based on the phase variations; and constructing the image of the one or more objects based on the wavelength-resolved modal decomposition and the turbulence-corrected image.

In embodiments, the techniques described herein relate to an imaging system, where the imaging sub-system further includes adaptive optics configured provide that the image is a turbulence-corrected image.

In embodiments, the techniques described herein relate to an imaging system, where the image has a resolution below a diffraction limit of the imaging sub-system.

In embodiments, the techniques described herein relate to an imaging system, where the imaging sub-system includes a telescope.

In embodiments, the techniques described herein relate to an imaging system, where the imaging sub-system includes a microscope.

In embodiments, the techniques described herein relate to an imaging system, further including a controller communicatively coupled to the one or more spectrometers, the controller including one or more processors configured to execute program instructions causing the one or more processors to determine wavelength-resolved measurements of at least one of an amplitude or a phase associated with modes of the input light.

In embodiments, the techniques described herein relate to an imaging system, where the one or more photonic lanterns include two photonic lanterns, where base modes associated with the wavelength-resolved modal decompositions of the two photonic lanterns are different, where the imaging system further includes at least one of a beamsplitter or a lenslet array to receive the input light and direct portions of the input light to the input waveguides of the two photonic lanterns.

In embodiments, the techniques described herein relate to an imaging system, where the one or more photonic lanterns include a single photonic lantern.

In embodiments, the techniques described herein relate to an imaging system, further including a controller communicatively coupled to the one or more spectrometers, the controller including one or more processors configured to execute program instructions causing the one or more processors to determine wavelength-resolved measurements of at least one of amplitudes and phases associated with modes of the input light.

In embodiments, the techniques described herein relate to an imaging system, where determining the wavelength-resolved measurements of at least one of amplitudes and phases associated with the modes of the input light includes determining the wavelength-resolved measurements of at least one of amplitudes or phases associated with the modes of the input light using a machine learning algorithm.

In embodiments, the techniques described herein relate to a sensor, where the machine learning algorithm is trained on wavelength-resolved modal decompositions associated with a plurality of configurations of the input light with known values of at least one of amplitudes or phases of associated modes.

In embodiments, the techniques described herein relate to an imaging system, where the one or more spectrometers include a single spectrometer with a single two-dimensional detector, where the imaging system further includes two or more optical fibers coupled with the two or more output waveguides of the one or more photonic lanterns, where output ends of the two or more optical fibers are arranged in a linear distribution along a first direction at an input of the single spectrometer, where the single spectrometer includes a dispersive element to disperse the light from the two or more optical fibers along a second direction orthogonal to the first direction.

In embodiments, the techniques described herein relate to an imaging system, where the waveguide structure of at least one of the one or more photonic lanterns includes a fiber waveguide structure.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a conceptual schematic of a wavefront-resolved photonic lantern wavefront sensor (WR-PLWFS) including a single photonic lantern, in accordance with one or more embodiments of the present disclosure.

FIG. 1B is a conceptual schematic of a WR-PLWFS including two photonic lanterns, in accordance with one or more embodiments of the present disclosure.

FIG. 2 is a conceptual schematic of a 3-mode photonic lantern providing modal decomposition of a flat wavefront and an aberrated wavefront.

FIG. 3 is a mapping of Zernike polynomials to linearly polarized Bessel fiber modes which naturally arise in photonic lanterns, in accordance with one or more embodiments of the present disclosure.

FIG. 4 is a conceptual illustration of wavefront phase profiles with their associated intensity point spread function (PSF) and projection on the linearly-polarized (LP) mode basis for two different aberration conditions, in accordance with one or more embodiments of the present disclosure.

FIG. 5 is a plot of simulated mode evolution of light in a photonic lantern with four output waveguides as a function of the lantern diameter, in accordance with one or more embodiments of the present disclosure.

FIG. 6 is an illustration of the mode evolution of light in a photonic lantern with four output waveguides and a total length of 40 mm, in accordance with one or more embodiments of the present disclosure.

FIG. 7A includes an image of the intensity distribution from the four output waveguides for an arbitrary input, in accordance with one or more embodiments of the present disclosure.

FIG. 7B includes a plot of simulated and measured centroids of the intensity distribution from the four output waveguides for multiple input conditions, in accordance with one or more embodiments of the present disclosure.

FIG. 8 is a schematic view of a high-contrast differential coronagraphic imager with a WR-PLWFS, in accordance with one or more embodiments of the present disclosure.

FIG. 9A includes a plot depicting 1σ wavefront error in the Z11 mode as a function of star brightness, assuming a 100 second exposure, in accordance with one or more embodiments of the present disclosure.

FIG. 9B includes a plot depicting integration time required to reach a 1 picometer wavefront error as a function of Zernike mode number for a star with V=5 mag, in accordance with one or more embodiments of the present disclosure.

FIG. 10 is a conceptual schematic of a QI imager including a WR-PLWFS, in accordance with one or more embodiments of the present disclosure.

FIG. 11 is a conceptual schematic of a QI imager with an imaging sub-system configured as a telescope for ground-based imaging of space debris.

FIG. 12A is a schematic of a 15-port photonic lantern, in accordance with one or more embodiments of the present disclosure.

FIG. 12B is a schematic of a capillary used to fabricate a 10-port photonic lantern, in accordance with one or more embodiments of the present disclosure.

FIG. 12C includes a microscope image of 10-channel photonic lantern and a microscope image of a 15-channel photonic lantern at input ends, in accordance with one or more embodiments of the present disclosure.

FIG. 12D includes theoretically expected and experimentally measured modal intensity profiles, in accordance with one or more embodiments of the present disclosure.

FIG. 13A is an image of a 37-fiber photonic lantern, where the inset is a cross-sectional micrograph of the input multimode core, in accordance with one or more embodiments of the present disclosure.

FIG. 13B is an image of a fabricated photonic lantern supporting 1156 spatial modes using the 34×34 core fiber, in accordance with one or more embodiments of the present disclosure.

FIG. 13C is a magnified image of the 34×34 core from FIG. 13B, in accordance with one or more embodiments of the present disclosure.

FIG. 13D is simplified perspective view a packaged and connectorized photonic lantern, in accordance with one or more embodiments of the present disclosure.

FIG. 14A is an image of a simulated simple sub-diffraction-limited object source function comprised of two small pieces separated by 5 cm at an altitude of 300 km separated by ˜0.5× the Rayleigh criterion on a 3.7-m telescope at visible wavelength and illuminated by the Sun with 30% albedo, in accordance with one or more embodiments of the present disclosure.

FIG. 14B is an image of a diffraction-limited light distribution of these object sources from FIG. 14A under these conditions, in accordance with one or more embodiments of the present disclosure.

FIG. 14C depicts simulated observed light distribution at the telescope based on time-variable phase aberrations introduced at the telescope pupil by atmospheric turbulence with a Kolmogorov power spectrum and cm, in accordance with one or more embodiments of the present disclosure.

FIG. 14D includes a simulation of the full modal measurement versus wavelength provided by the QI imager 1000, in accordance with one or more embodiments of the present disclosure.

FIG. 14E is a simulated image (wavelength-stacked) after application of the reconstruction techniques described previously herein that includes simulated spectral detector illumination, in accordance with one or more embodiments of the present disclosure.

FIG. 14F is a plot of the spectral intensity of the two diverse objects generated using the simulated QI imager, in accordance with one or more embodiments of the present disclosure.

FIG. 14G is a plot of the modal decomposition derived from FIG. 14D and used to generate the data for FIGS. 14E-14F, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to a wavelength-resolved photonic lantern wavefront sensor (WR-PLWFS). A WR-PLWFS may include at least one photonic lantern with a single input waveguide and multiple (e.g., two or more) output waveguides and may further include a spectrometer arranged to provide spectral measurements (e.g., wavelength-resolved measurements) of light from each of the output waveguides. In this way, the intensities of light exiting the output waveguides of a photonic lantern may correspond to a modal decomposition of input light coupled into the input waveguide of the photonic lantern. Further, the spectrometer may provide wavelength-resolved measurements of this modal decomposition and may thus provide a wavelength-resolved modal decomposition of the input light.

Additional embodiments of the present disclosure are directed to systems and methods incorporating a WR-PLWFS.

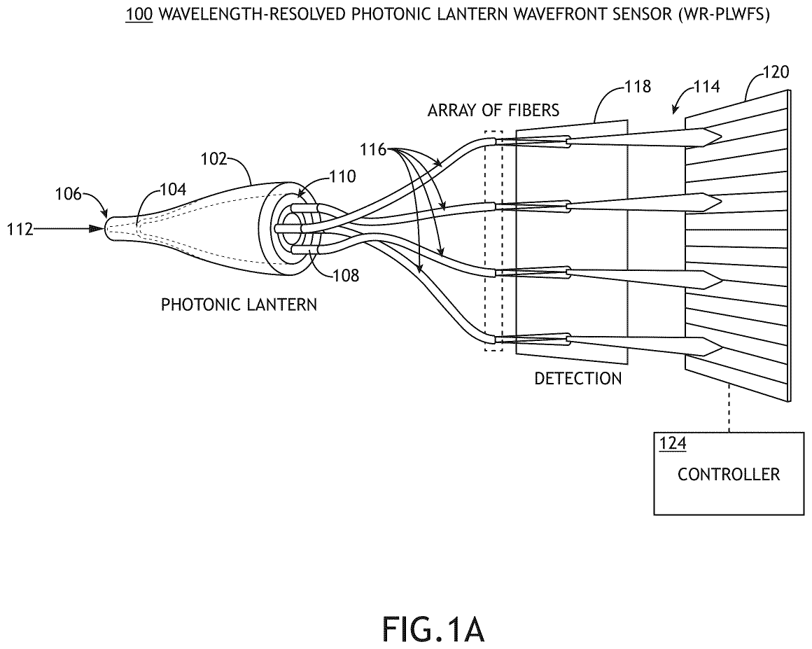

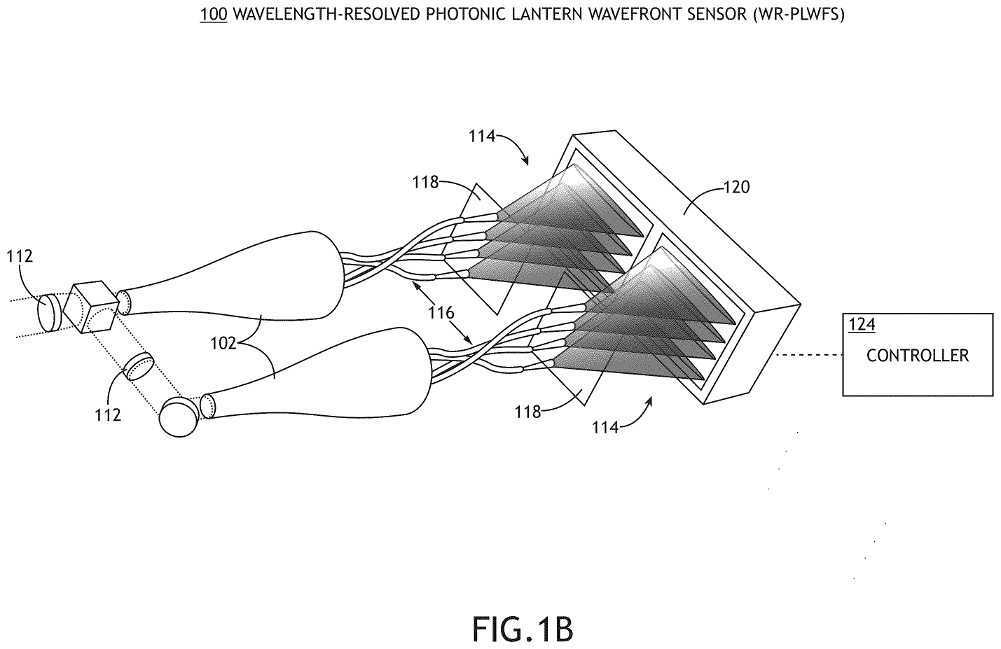

Referring now to FIGS. 1A-14, a WR-PLWFS and associated systems and methods are described in greater detail, in accordance with one or more embodiments of the present disclosure.

FIG. 1A is a conceptual schematic of a WR-PLWFS 100 including a single photonic lantern 102, in accordance with one or more embodiments of the present disclosure. FIG. 1B is a conceptual schematic of a WR-PLWFS 100 including two photonic lanterns 102, in accordance with one or more embodiments of the present disclosure. In a general sense, a WR-PLWFS 100 may include any number of photonic lanterns 102.

A photonic lantern 102 be formed as a waveguide structure with a single input waveguide 104 at an input end 106 and two or more output waveguides 108 at an output end 110, where the output waveguides 108 are optically decoupled. In this configuration, a distribution of intensities of light exiting output waveguides 108 corresponds to a modal decomposition of input light 112 coupled into the input waveguide 104. A photonic lantern 102 may be fabricated using any suitable technique. For example, a photonic lantern 102 may be formed as a fiber device in which the input end 106 and the output waveguides 108 are formed from optical fibers that are adiabatically coupled. As another example, a photonic lantern 102 may be formed as an integrated waveguide device. Photonic lanterns are generally described in Velázquez-Benítez, A. M., Antonio-López, J. E., Alvarado-Zacarías, J. C., Fontaine, N. K., Ryf, R., Chen, H., & Amezcua-Correa, R. (2018). Scaling photonic lanterns for space-division multiplexing. Scientific reports, 8(1), 8897, which is incorporated herein by reference in its entirety.

In some embodiments, a WR-PLWFS 100 includes one or more spectrometers 114 coupled to the output waveguides 108 of one or more photonic lanterns 102 and arranged to measure the spectra of light exiting the output waveguides 108. In this configuration, the spectra may correspond to or otherwise provide a wavelength-resolved modal decomposition of the input light 112.

A spectrometer 114 may be coupled to one or more output waveguides 108 using any technique known in the art. In some embodiments, the WR-PLWFS 100 includes one or more optical fibers 116 (e.g., a fiber array) to provide coupling between the output waveguides 108 and a spectrometer 114. In some embodiments, though not explicitly shown, a WR-PLWFS 100 includes one or more optics to provide free-space coupling between the output waveguides 108 and a spectrometer 114.

The WR-PLWFS 100 may include any number of spectrometers 114 of any design suitable for capturing the spectra of light from the output waveguides 108 of one or more photonic lanterns 102.

In some embodiments, one or more spectrometers 114 are formed from at least one dispersive element 118 (e.g., a diffraction grating, a prism, or the like) to spectrally disperse light from an output waveguide 108 onto at least one detector 120. The dispersive element 118 may include any component or combination of components that spectrally disperse light such as, but not limited to, a diffraction grating or a prism. Further, the dispersive element 118 may operate in a transmission mode or a reflection mode. The detector 120 may include any suitable component or combination of components suitable for capturing spectrally dispersed light from the dispersive element 118. For example, the detector 120 may include a multi-pixel sensor such as, but not limited to, a charge-coupled device (CCD) or a complementary metal-oxide-semiconductor (CMOS) device. As another example, the detector 120 may include an array of single-pixel devices such as, but not limited to, photodiodes or avalanche photodiodes. Further, each spectrometer 114 may include a dedicated detector 120 or one or more detectors 120 may be shared between two or more spectrometers 114.

In some embodiments, the spectrometer 114 is formed as a simple collimator/camera optical relay with a reflective double-pass BK7 prism for the dispersive element 118. For example, the collimator may include a stock lens achromat, while the detector 120 may consist of a stock lens achromat with a custom field flattener in front of the CCD sensor. Such a design may provide spectral resolution from R˜50 (at the blue end, where the prism glass dispersion is highest) to R˜20 (at the red end) and covers a bandpass from 400-1000 nm on a 100×150-pixel region of the detector 120. However, this is merely an illustration and should not be interpreted as limiting the scope of the present disclosure.

In some embodiments, the WR-PLWFS 100 includes different spectrometers 114 dedicated to different output waveguides 108. In some embodiments, the WR-PLWFS 100 includes at least one spectrometer 114 configured to measure the spectra of two or more output waveguides 108. For example, FIG. 1A depicts a single spectrometer 114 configured to simultaneously measure the spectra from all four output waveguides 108 of a photonic lantern 102. In FIG. 1A, optical fibers 116 are arranged with output ends in a linear distribution (here a vertical direction) at an input of a single spectrometer 114 (e.g., at an input slit of the spectrometer 114 or an image thereof). Further, FIG. 1A depicts a single dispersive element 118 arranged to spectrally disperse the light from the output waveguides 108 along an orthogonal direction (here a horizontal direction) and a single detector 120 (e.g., a two-dimensional multi-pixel sensor) to simultaneously capture the spectra of light from all of the output waveguides 108. In particular, the spectra associated with each output waveguide 108 is incident on a different portion of the detector 120. As another example, FIG. 1B depicts two spectrometers 114, each arranged to simultaneously capture the spectra from all output waveguides 108 of a dedicated photonic lantern 102. Further, FIG. 1B depicts a non-limiting configuration in which the two spectrometers 114 share a common detector 120. FIG. 1B further depicts a beamsplitter 122 to direct portions of input light 112 to each of the photonic lanterns 102. It is to be understood, however, that FIGS. 1A and 1B are provided solely for illustrative purposes and should not be interpreted as limiting. In a general sense, a WR-PLWFS 100 may include any number or combination of photonic lanterns 102 and spectrometers 114 (or portions thereof) suitable for measuring the spectra of each output waveguide 108 of each photonic lantern 102.

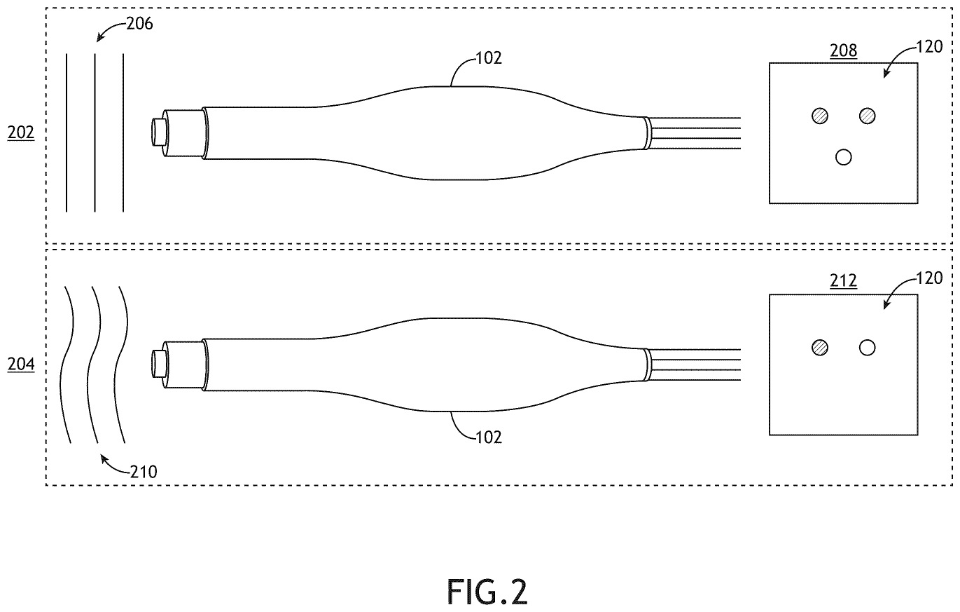

Referring now to FIGS. 2-7, the operation of a photonic lantern 102 to provide modal decomposition is described in greater detail, in accordance with one or more embodiments of the present disclosure. It is noted that a WR-PLWFS 100 that further includes a spectrometer 114 may capture spectrally-resolved modal decompositions, though this is not illustrated in FIGS. 2-7 for clarity.

It is contemplated herein that a photonic lantern 102 having N output waveguides 108 (N being an integer greater than one) may provide a modal decomposition of input light 112 into an orthonormal set of N base modes, where the intensity of each output waveguide 108 may encode a combination of amplitude and phase information for a particular mode. Further, spectra of light from each output waveguide 108 (e.g., as measured by a spectrometer 114) may provide such information as a function of wavelength.

FIG. 2 is a conceptual schematic of a 3-mode photonic lantern 102 (e.g., a photonic lantern 102 having three output waveguides 108) providing modal decomposition of an flat wavefront (panel 202) and an aberrated wavefront (panel 204). In particular, panel 202 depicts a flat wavefront 206 entering the photonic lantern 102 and providing a first distribution 208 of intensities of light from the output waveguides 108 (e.g., on a detector 120). The panel 204 depicts an aberrated wavefront 210 entering the photonic lantern 102 and providing a second distribution 212 of intensities of light from the output waveguides 108. In this way, information about an arbitrary wavefront of input light 112 may be determined based on the distribution of intensities in the associated output waveguides 108.

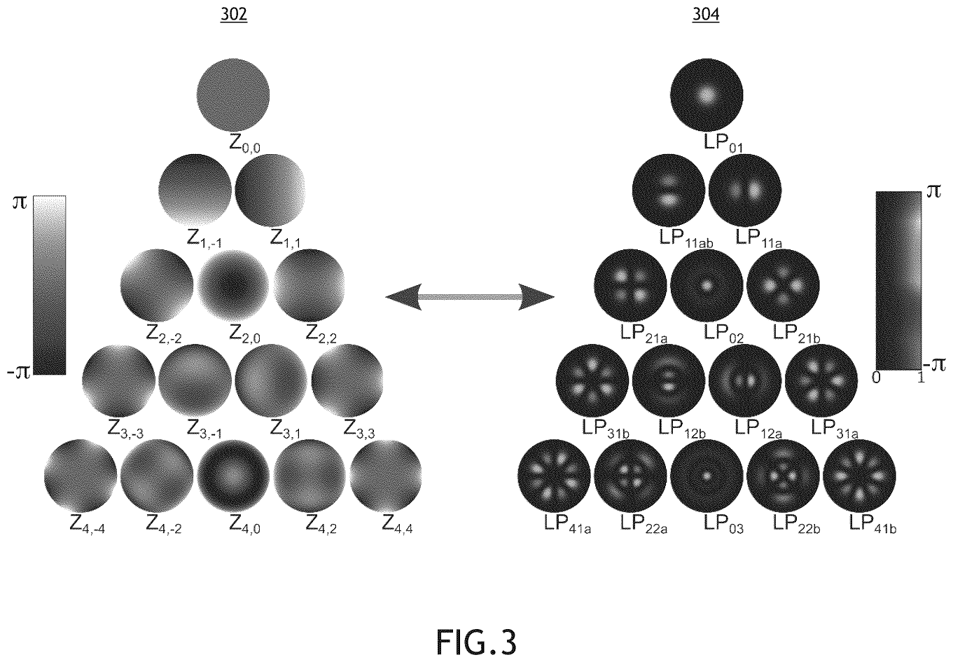

More generally, Bessel modes comprise the base set of the modal decomposition (e.g., as opposed to Zernike modes) that may be commonly used to describe wavefront aberrations in free space systems. Nevertheless, both the Bessel modes and Zernike modes are simply orthonormal basis sets used to span the input wavefront space. In addition, for each Zernike mode, there is a Bessel mode that features the same phase profile. Thus, one can compose any set of Zernike polynomials for a given wavefront from the equivalent Bessel modes. FIG. 3 is a mapping of Zernike polynomials (panel 302) to the linearly polarized Bessel fiber modes (panel 304) which naturally arise in photonic lanterns 102, in accordance with one or more embodiments of the present disclosure. The greyscale map in panel 302 on the left shows the phase distribution over the unit disk associated with each Zernike mode. In panel 304 on the right, the greyscale value corresponds to the phase distribution of the Bessel fiber mode, while the brightness corresponds to the amplitude of the mode. Bessel fiber modes are commonly called linearly polarized or (LP) modes. Each Zernike polynomial can be correlated to a distinct Bessel mode so that the wavefront is equally described in both bases.

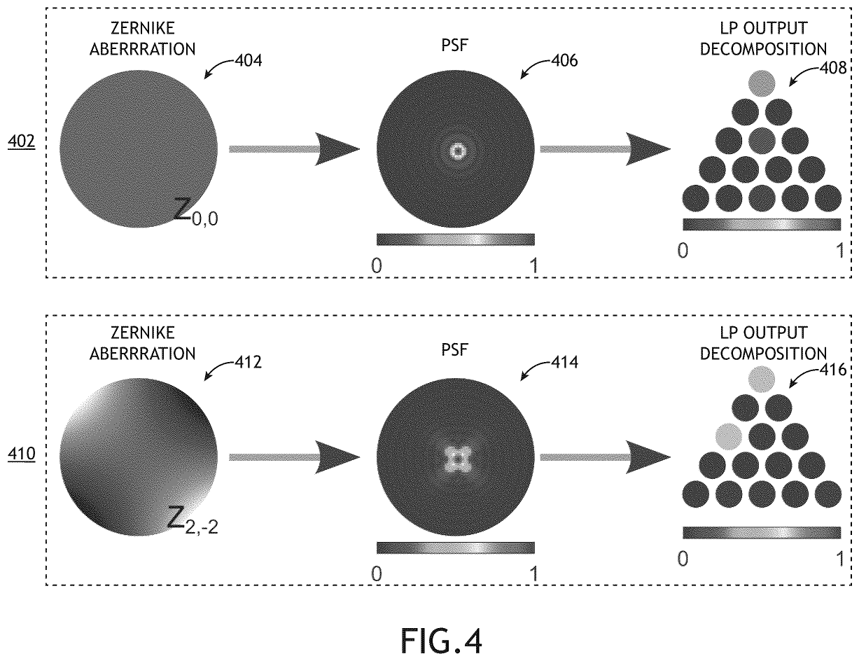

FIG. 4 is a conceptual illustration of wavefront phase profiles with their associated intensity point spread function (PSF) and projection on the LP mode basis for two different aberration conditions, in accordance with one or more embodiments of the present disclosure. In panel 402, the piston Zernike mode (Z_{0,0}) 404 produces an Airy pattern in the focal (PSF) plane 406, which can be decomposed into the LP modes 408 of the photonic lantern. In panel 410, astigmatism aberrations given by Zernike mode (Z_{2, -2}) 412 produce a different PSF distribution 414 and a different distribution of LP modes 416 (e.g., different projections on the LP basis). Note the direct mapping of Zernike to LP modes in both cases, where the LP mode orders are arranged as in FIG. 3. In particular, panel 402 illustrates light in the LP₀₁ mode, whereas panel 410 depicts light in both the LP₀₁ mode and the LP21a mode as indicated by the greyscale values of the associated modes.

A photonic lantern 102 may generally have any number (e.g., N where N is an integer greater than one) of output waveguides 108 and thus generally provide modal decomposition into any number of bases. In this way, phase and amplitude information associated with the various LP modes of light coupled into the input waveguide 104 may be encoded into the distribution of intensities in the N output waveguides 108 according to an orthonormal set of base modes.

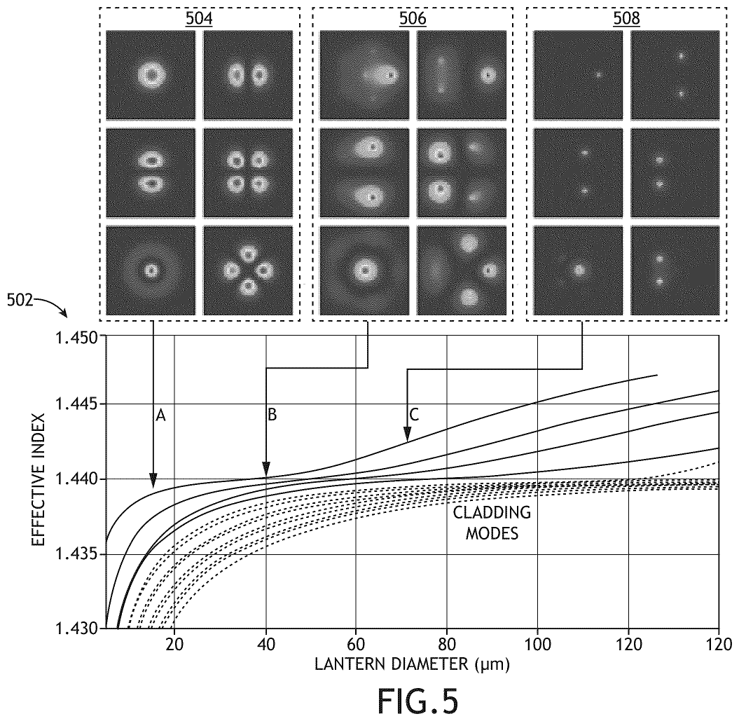

FIG. 5 is a plot 502 of simulated mode evolution of light in a photonic lantern 102 with four output waveguides 108 (N=4) as a function of the lantern diameter (e.g., waveguide tapering factor), in accordance with one or more embodiments of the present disclosure. Inset 504 depicts images of various modes at a first diameter (˜10 μm), inset 506 depicts images of various modes at a second diameter (˜40 μm), and inset 508 depicts images of various modes at a second diameter (˜65 μm). As in a conventional optical fiber, a photonic lantern supports two types of modes: core modes (propagating with high efficiency) (shown as solid lines) and cladding modes (exhibiting high losses) (shown as dashed lines). High efficiency photonic lanterns 102 require a clear separation of these two types of modes across the taper length, as shown in FIG. 5. Critically, FIG. 5 also illustrates that as the diameter of the photonic lantern 102 increases, the multimode modes (A) become spatially separated intensity patterns in the various output waveguides 108 of the lantern (C). In this regard, phase/amplitude variations of an incident wavefront (e.g. tip and tilt) map to different combinations of modes at the input of the photonic lantern 102 which in turn produce unique intensity patterns at the output waveguides 108. As such, one can determine the phase profile of the wavefront by monitoring the distribution of intensities of the output waveguides 108.

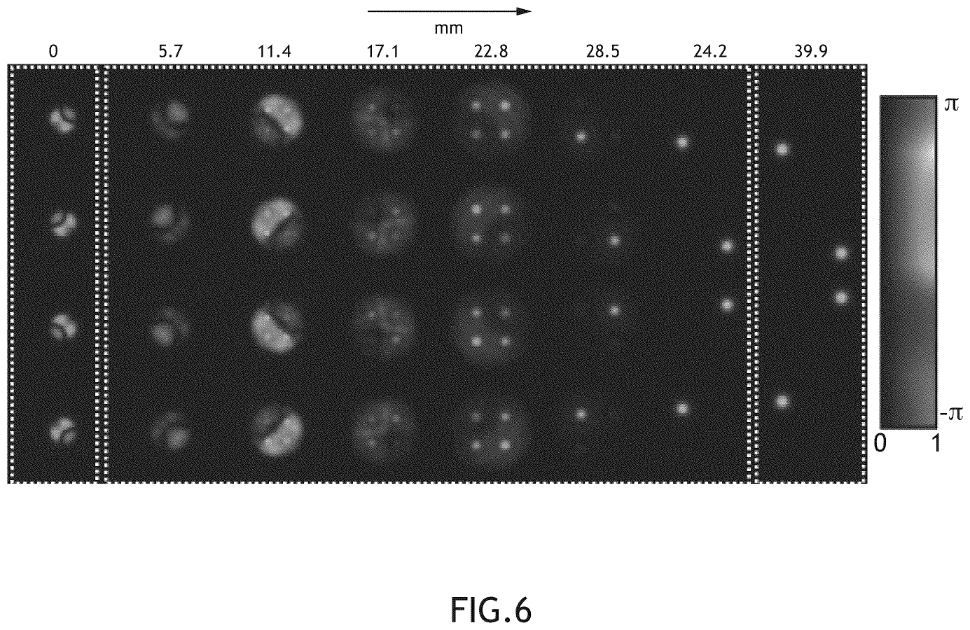

FIG. 6 is an illustration of the mode evolution of light in a photonic lantern 102 with four output waveguides 108 (N=4) and a total length of 40 mm, in accordance with one or more embodiments of the present disclosure. In particular, FIG. 6 depicts a mapping of the input light 112 field (e.g., at 0 mm) to the mode intensity in each of the output waveguides 108 of the photonic lantern 102, where the greyscale map represents the phase of the light, while brightness indicates the intensity of the light. Further, the columns represent selected positions along the length of the photonic lantern 102. In a telescope setting, such input light 112 may correspond to a stellar point-spread-function (PSF) from a high-contrast imaging system. Note that the complicated amplitude/phase distribution at the input field maps to simple intensity distributions at the output waveguides 108 (see e.g., Cruz-Delgado, Daniel, Juan Carlos Alvarado-Zacarias, Matthew A Cooper, Steffen Wittek, Caleb Dobias, Julian Martinez-Mercado, Jose E Antonio-Lopez, Nicolas K Fontaine, Rodrigo Amezcua-Correa, 2021, Opt. Lett., 46, 13, 3292, which is incorporated herein by reference in its entirety).

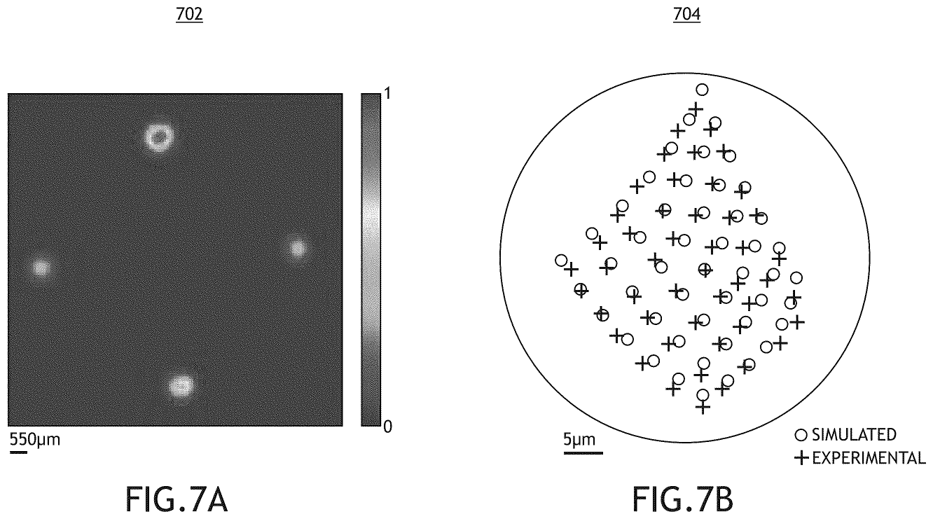

FIGS. 7A-7B depict an experimental demonstration of the photonic lantern 102 characterized in FIG. 6, in accordance with one or more embodiments of the present disclosure. FIG. 7A includes an image 702 of the intensity distribution from the four output waveguides 108 for an arbitrary input, in accordance with one or more embodiments of the present disclosure. FIG. 7B includes a plot 704 of simulated and measured centroids of the intensity distribution from the four output waveguides 108 (e.g., centroids of distributions such as depicted shown in image 702) for multiple input conditions, in accordance with one or more embodiments of the present disclosure. In this experiment, the multiple input conditions corresponded to low-order aberrations of input light 112 controlled using a spatial light modulator (not shown). As shown in FIGS. 7A-7B, the experimental measurements are in excellent agreement with the numerical simulations, confirming their accuracy.

In a general sense, the number of output waveguides 108 of a photonic lantern 102 in a WR-PLWFS 100 may be selected based on the requirements of each particular application. As a non-limiting illustration, a photonic lantern 102 with approximately 30 output waveguides 108 (e.g., N=30) may be suitable for highly precise measurements for applications such as, but not limited to, the Low-Order Wavefront Sensor (LOWFS) of the HabEx and LUVOIR design concepts for NASA missions for detection of habitable extrasolar planets around other stars.

It is further contemplated herein that the amplitude and phase information associated with an N-mode decomposition of the input light 112 may be uniquely and independently determined using two photonic lanterns 102 with different sets of N base modes. For example, the particular set of base modes of each photonic lantern 102 may be associated with the particular design and fabrication characteristics of the photonic lantern 102 such that minor structural deviations may result in different mode mappings with different base modes. In this way, modal decompositions with two N-mode photonic lanterns may provide sufficient data to determine both intensity and phase information of an N-mode decomposition of the input light. Put another way, amplitude and phase information for an N-mode decomposition represents 2N unknowns, which may be determined using 2N intensity measurements of the 2N output waveguides from two N-mode photonic lanterns. Additionally, spectra of light from each of the 2N output waveguides may provide such information as a function of wavelength.

In noted, however, that an N-mode decomposition of input light from a single photonic lantern may be sufficient for some applications. For example, an N-mode decomposition of input light from a single photonic lantern may be sufficient for measurements of low-order aberrations of an otherwise near ideal wavefront. Further, various calibration techniques may be used to infer the complete phase and amplitude information of input light. For example, a machine learning algorithm may be used to determine wavelength-resolved measurements of at least one of amplitudes or phases associated with modes of input light. Any type or combination of types of machine learning algorithm may be used such as, but not supervised learning, unsupervised learning, or reinforcement learning technique. As an illustration incorporating supervised learning, a machine learning algorithm may be trained with N-mode decompositions of input light from a single photonic lantern with known phase and amplitude information. Such a trained machine learning algorithm may then infer full phase and amplitude information of input light with unknown characteristics.

Referring again to FIG. 1A-1B, in some embodiments, the WR-PLWFS 100 includes a controller 124 that may be coupled with any components therein. In some embodiments, the controller 124 includes one or more processors configured to execute program instructions stored on a memory, or memory device. In this way, the program instructions may cause the one or more processors to implement various steps. The controller 124 may include any processor or processing element known in the art such as, but not limited to, a microcontroller, a digital signal processor, a field-programmable gate array (FPGA) device or an application-specific integrated controller (ASIC) device. Further, the controller 124 may be configured to execute program instructions stored on any type of memory device such as, but not limited to, a non-transitory memory medium, random-access memory, read-only memory, an electronic memory device, an optical memory device, or a magnetic memory device. In some embodiments, the controller 124 is configured to receive data from components of the WR-PLWFS 100 such as, but not limited to, a detector 120. In this way, the controller 124 may implement any algorithms or analysis steps disclosed herein. In some embodiments, the controller 124 is configured to direct (e.g., via one or more control signals) components of the WR-PLWFS 100 to perform actions. In this way, the controller 124 may directly or indirectly implement any measurement or analysis steps disclosed herein.

Such a controller may receive data from the one or more spectrometers 114 (e.g., a detector 120 therein) corresponding to spectra of the light from the output waveguides 108 and may further generate one or more outputs. For example, the controller may determine amplitude and/or phase information associated with various modes of the input light 112. As another example, the controller may implement a machine learning algorithm as described above. As another example, the controller 124 may control, via control signals, any of the components of the WR-PLWFS 100.

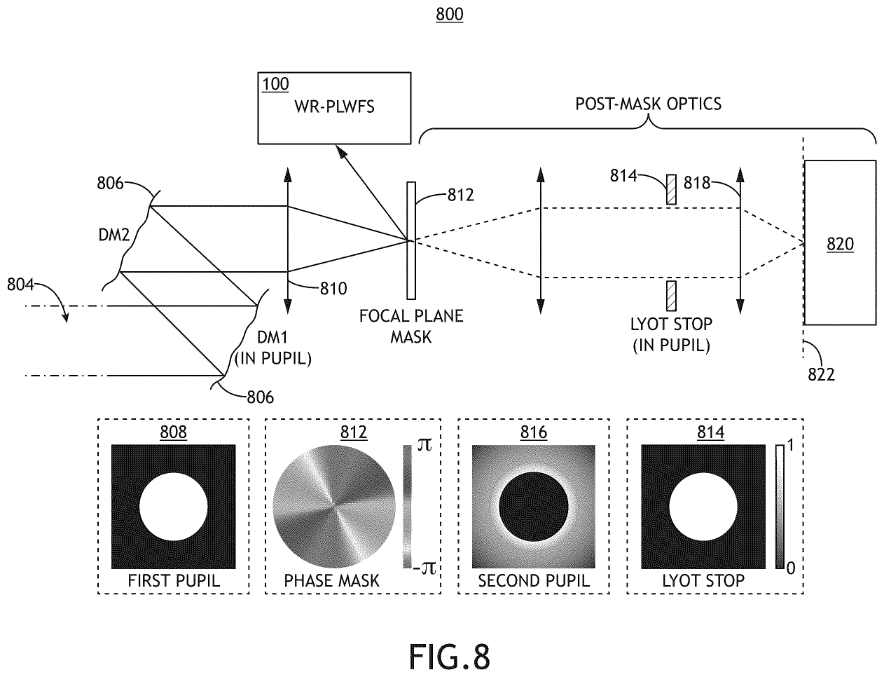

Referring now to FIGS. 8-14, various applications of a WR-PLWFS 100 within larger systems are described in greater detail, in accordance with one or more embodiments of the present disclosure.

Some embodiments of the present disclosure are directed to systems and methods incorporating a WR-PLWFS 100 as a field plane wavefront sensor (FPWFS). A WR-PLWFS 100 operating as a FPWFS may be implemented in any type of imaging system known in the art. For example, a WR-PLWFS 100 may be placed directly in a field plane (e.g., a focal plane) of an imaging system (e.g., within a gap in an imaging detector or detector array). As another example, a WR-PLWFS 100 may be placed in a conjugate field plane (e.g., generated in an alternative path using a beamsplitter, a wedge, or other pickoff optic).

In some embodiments, a coronagraph imaging system includes a WR-PLWFS 100 in a focal plane. For example, the US Astro2020 Decadal Survey has identified the top priority for NASA's next major missions to be detecting habitable extrasolar planets around other stars. The leading design concepts for such a mission (currently HabEx and LUVOIR, though it is noted that the present disclosure is not limited to such systems) aim to achieve this scientific goal via extremely high-contrast imaging at ˜10⁻¹⁰, and this in turn demands exquisite knowledge and control of the system optical wavefront. It is important to note that the leakage of even a tiny fraction of starlight into the focal plane can swamp the weak signals emitted by Earth-like planets in the Habitable Zone of Sun-like stars. It is contemplated herein that a WR-PLWFS 100 operating as a FPWFS may provide wavefront sensing in a way that meets or exceeds the requirements for such a coronagraph.

FIG. 8 is a schematic view of a high-contrast differential coronagraphic imager 802 with a WR-PLWFS 100, in accordance with one or more embodiments of the present disclosure. Coronagraphic imaging is generally described in Ruane. G., Henry Ngo, Dimitri Mawet, Olivier Absil, Élodie Choquet, Therese Cook, Carlos Gomez Gonzalez, Elsa Huby, Keith Matthews, Tiffany Meshkat, 2019, AJ, 157, 118; which is incorporated herein by reference in its entirety. In this configuration, light 804 from a telescope is collimated before entering from the left and passing through two deformable mirrors 806 (DM1 and DM1), one of which is at the telescope exit pupil image. Inset 808 depicts an exemplary stop configured to pass this collimated light in a first pupil. Light is then refocused (e.g., by one or more focusing elements 810) onto a vector vortex phase mask 812 (e.g., a focal plane mask), which then passes light through an undersized Lyot stop 814 at the next pupil image 816 before being focused (e.g., by one or more focusing elements 818) onto the science detector 820 at a detector focal plane 822. The coronagraphic imager 802 may further include various additional lenses 824 or other optical elements suitable for providing a desired image. In FIG. 8, light rejected by the vortex mask 812 is collected by the WR-PLWFS 100 as input light 112. Further, the WR-PLWFS 100 in FIG. 8 may be located at a field plane conjugate to the science detector 820.

In some embodiments, though not explicitly shown, the WR-PLWFS 100 may be implemented in the detector focal plane 822 (e.g., in a gap between sensor elements of the science detector 820). For example, the input diameter of a photonic lantern 102 of a WR-PLWFS 100 may be on the order of 40 μm or less and may thus be incorporated into the detector focal plane 822 with minimal impact on the performance of the coronagraphic imager 802.

It is contemplated herein that performance of such as system may be limited by residual “speckles” transmitted to the detector focal plane 822. These speckles can be very bright compared to real exoplanet signals (even if they constitute only a tiny fraction of the incident starlight) and can mimic the angular structure of exoplanet signatures. These arise from a multitude of sources, many of which ultimately come down to Non-Common-Path Aberrations (NCPA) between the wavefront sensor and the science detector focal plane.

It is further contemplated herein that a WR-PLWFS 100 operating as a FPWFS in a detector focal plane 822 or a conjugate thereof may provide (near) common path measurements and can thus be used to eliminate speckles and NCPA more generally. In this way, a WR-PLWFS 100 may be implemented behind the coronagraphic mask (eliminating NCPA) and/or as a primary coronagraphic wavefront sensor. Further, such a WR-PLWFS 100 may beneficially provide high-resolution, broadband operation without moving parts and without introducing additional light into the system that may degrade system performance.

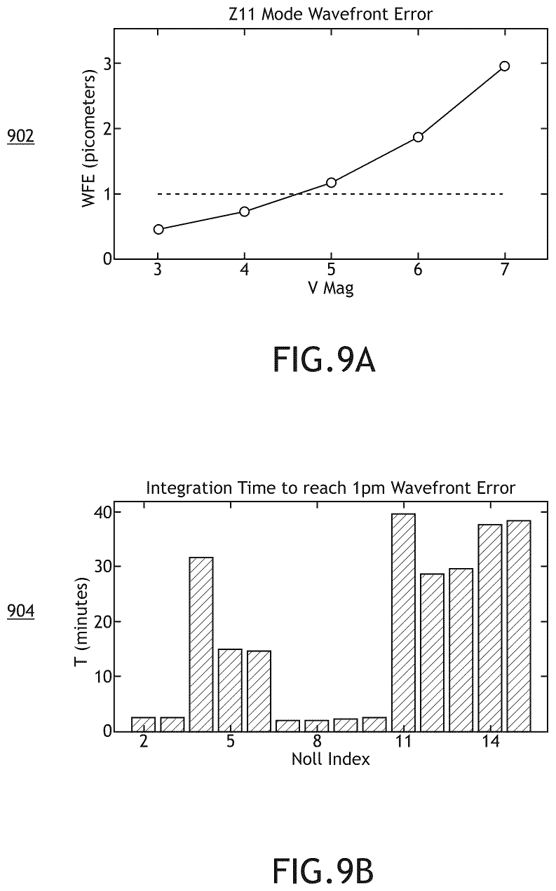

FIGS. 9A-9B include simulated plots of the performance of a WR-PLWFS 100 in a coronagraphic imager 802 as depicted in FIG. 8, in accordance with one or more embodiments of the present disclosure. FIG. 9A includes a plot 902 depicting 10 wavefront error in the Z1,1 mode (a tip/tilt mode) as a function of star brightness, assuming a 100 s exposure, in accordance with one or more embodiments of the present disclosure. FIG. 9B includes a plot 904 depicting integration time required to reach a 1 picometer wavefront error as a function of Zernike mode number for a star with V=5 mag, in accordance with one or more embodiments of the present disclosure.

In this simulation, it is assumed that the WR-PLWFS 100 has access to the 400-1000 nm bandpass of the target star light rejected by the vector phase mask, with an efficiency of 10% (including all optical losses and detector quantum efficiency). FIGS. 9A-9B illustrate the noise-equivalent wavefront error for Zernike mode Z11 as a function of star brightness for a 100 s exposure time, assuming photon-noise-limited detector performance. FIGS. 9A-9B further illustrate the time to a wavefront uncertainty of 1 picometer for the first 15 Zernike modes in FIG. 9 for a star with V=5 mag.

It is noted that this performance provides an excellent match to the requirements for high-contrast coronagraphic imaging. In fact, the time needed is less than that for alternative technologies such as, but not limited to, a Zernike wavefront sensor with a similar star by a factor of ˜2, as might be expected given the much broader bandpass of the wavelength-resolved WR-PLWFS 100.

It is further contemplated herein that a WR-PLWFS 100 may provide numerous additional advantages over alternative technologies.

For example, photonic lanterns 102 are intrinsically broadband in nature, with their bandpass limited primarily by the materials used in their fabrication. As an illustration, photonic lanterns 102 have been developed to operate at visible-wavelengths with high efficiency (>90%) over bandpasses of 400-1000 nm (e.g., Moraitis et al., 2021). Further, a non-limiting example of a WR-PLWFS 100 with a 30-mode photonic lantern 102 (e.g., as described with respect to FIGS. 6 and 7) provides a spectral resolution of R=λ/Δλ ˜20 and a 400-1000 nm bandpass. This provides approximately 5×the bandpass and 6×the resolution of a typical Zernike WFS (see e.g., Wang, Xu; Shi, Fang; Wallace, J. Kent, 2016, Proc. Of SPIE, 9904, 63; which is incorporated herein by reference in its entirety). As another example, a WR-PLWFS 100 may be relatively small, compact, unobtrusive, and robust due to their monolithic construction.

As another example, the large wavelength range allows the measurement of the wavefront amplitude and phase at wavelengths both shorter than the science bandpass AND longer than the science bandpass simultaneously during science observations. This enables “loop closure” on NCPA using out-of-band sensing to fully constrain the in-band wavefront. This is a fundamental improvement that provides a systematic advantage over a Zernike wavefront sensor (ZWFS) and other limited-bandpass approaches.

As another example, the broader bandpass also allows a substantial increase in the number of photons (typically by a factor of 2× to 4× relative to a ZWFS depending on the spectral type of the target star). This in turn increases the signal-to-noise ratio versus time for a given target, enabling high SNR sensing, and/or faster sensing, as well as targeting fainter and more distant stars. Since the number density of stars is roughly inversely proportional to flux, this will more than double the number of available target stars (and thus habitable planets) during operation.

As another example, shorter wavelength sensing naturally improves the resolution of the wavefront measurement in nanometers, while longer-wavelength sensing tends to give higher dynamic range (or “stroke”). The broadband nature of this approach enables the system to experience both of these advantages at once, while limited-bandpass approaches must choose one or the other, relative to the science band.

As another example, the spectral resolution R is easily selectable in the optical design of the dispersing system. Furthermore, measurements can be binned on-chip or in post-processing to trade wavelength resolution with signal-to-noise ratio. This provides flexible optimization of the wavefront sensing to match the needs of disparate targets and science/operational cases.

As another example, this approach is fundamentally compatible with other wavelength-resolving technologies. This could include dispersive spectrographs relying on integrated optics such as Arrayed Waveguide Grating (AWG) spectrographs or energy-sensitive detectors such as Microwave Inductance Sensors without a dispersive component.

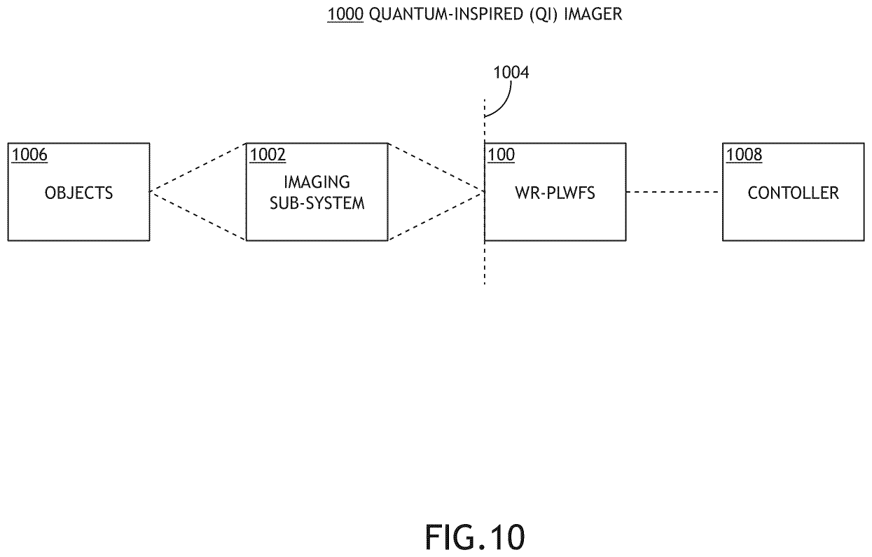

Referring now to FIGS. 10-14, some embodiments are directed to a quantum-inspired (QI) imager including a WR-PLWFS 100. It is contemplated herein that QI imaging may enable resolving powers beyond the diffraction limit (DL) of a classical imaging system, with a main constraint for implementing QI imaging is the need for a device to perform spatial mode demultiplexing in an efficient and accurate manner. QI imaging is described generally in M. Matlin, E. F., Zipp, L. J. “Imaging arbitrary incoherent source distributions with near quantum-limited resolution,” Nature Sci Rep 12, 2810 (2022); which is incorporated herein by reference in its entirety. It is contemplated herein that a WR-PLWFS 100 as disclosed herein may perform such spatial mode demultiplexing with broadband capabilities in a passive, efficient, and compact package.

FIG. 10 is a conceptual schematic of a QI imager 1000 including a WR-PLWFS 100, in accordance with one or more embodiments of the present disclosure. In some embodiments, a QI imager 1000 includes an imaging sub-system 1002 and a WR-PLWFS 100 at a field plane 1004 (e.g., a focal plane) of the imaging sub-system 1002. In this configuration, the QI imager 1000 may image objects 1006 onto the field plane 1004. Further, the QI imager 1000 may include a controller 1008 communicatively coupled to at least the WR-PLWFS 100. The controller 1008 may be similar to the controller 124 described with respect to FIGS. 1A-1B. The controller 124 may receive data from the WR-PLWFS 100 (e.g., spectra of light exiting the output waveguides 108) representative of the modal decomposition of input light 112 and perform various processing steps such as, but not limited to, generating an image based on QI techniques using the data from the WR-PLWFS 100.

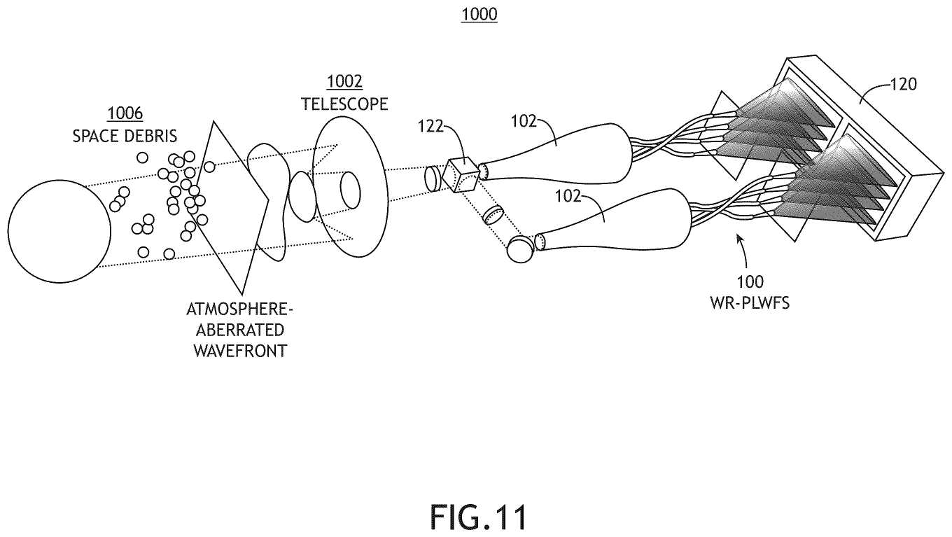

It is contemplated herein that a QI imager 1000 may be implemented in a wide range of applications with different configurations of the imaging sub-system 1002 and associated processing steps based on the particular characteristics of the objects 1006 being imaged and/or their surrounding environment. FIGS. 11-14 describe a QI imager 1000 suitable for telescopic imaging applications such as, but not limited to, imaging space debris from ground-based telescopes or space-based imaging of the Earth. Additional applications in the area of microscopic imaging are then described.

FIG. 11 is a conceptual schematic of a QI imager 1000 with an imaging sub-system 1002 configured as a telescope for ground-based imaging of space debris (the objects 1006). FIG. 11 further depicts a WR-PLWFS 100 including two photonic lanterns 102 (e.g., as depicted in FIG. 1B) to provide a modal decomposition with complete amplitude and phase information as described previously herein.

Space debris presents a serious threat to future space research and commercialization for the United States and the world at large. Space debris has been an increasing problem since the launch of the first artificial satellite in 1957 marking the beginning of the space age. The potentially catastrophic effects of “space junk” are being voiced not only by NASA, but the Space Force, the entire commercial space industry, and the US President. Current studies estimate 100 million pieces of space debris in orbit, many of which are too small to track with current imaging technology. Debris as small as a marble traveling at an orbital velocity of 17,500 mph can cause mission-ending damage to spacecraft and satellites. This could potentially destroy capabilities to monitor hurricanes, distribute GPS navigation signals, and provide critical communication links to tactical personnel protecting US national security in hazardous areas across the globe. Due to the potential damage from such small objects, the White House has published a National Orbital Debris Implementation Plan (2021-2022), emphasizing the need to limit the debris created during space operations, and pushing for improved capabilities in tracking, characterizing, and even removing the space debris. It is standard operating procedure to monitor the space domain within a large area near spacecraft such that operators have enough time to enact evasive maneuvers if debris crosses into the designated area. The International Space Station requires a 2.5×30×30 mile imaginary box for this reason. Additionally, advances in space technology and operations bring new risks of active and passive space-to-space operations against spacecraft/satellites under the guise of space debris.

A crucial first step towards mitigating the threat posed by space debris is improved information on the nature of space debris objects, including, the size, shape, composition, rotation, and time evolution of individual objects. Imaging angular resolution poses a significant challenge for measuring these properties due to the key limiting factors of diffraction and atmospheric turbulence. Atmospheric turbulence degrades image resolution by perturbing the phase of an incident wavefront propagating through the varying density (and thus optical refractive index) of turbulent cells. These cells create a Kolmogorov power spectrum of phase variations which change on timescales of ˜100 to 1000 Hz, depending on the prevalent atmospheric conditions and wind speeds. The typical optical coherence length of the atmosphere, the Fried parameter r₀, ranges from a few cm to 10+cm in the visible band and produces time-averaged profiles resembling Gaussian Point Spread Functions (PSFs) with typical sizes of ˜Δ/r₀ full width at half maximum (FWHM). Uncorrected, these atmospheric effects would limit study of space debris objects to size scales >1-meter at Low Earth Orbit (LEO) and >100-meters at Geostationary Orbit (GEO).

A current high-cost solution to this longstanding problem uses an adaptive optics (AO) system to first sense the wavefront aberrations produced by the atmosphere, and then correct them with a deformable mirror optically conjugated to one or more turbulent layers in the atmosphere. Such systems generally require a reference light source (either a natural or laser-generated guide star) to provide sufficient light to measure the aberrations at the ˜1-10 ms coherence timescales of the atmosphere. Most AO systems to-date work at near-infrared wavelengths, where the larger atmospheric Fried parameter makes wavefront correction more tractable. These systems can produce images at the diffraction limit of the telescopes, with PSFs at FWHM ˜λ/D. AO imaging is described generally in Carson, Eikenberry et al, The Cornell High-Order Adaptive Optics Survey for Brown Dwarfs in Stellar Systems. I. Observations, Data Reduction, and Detection Analyses, 2005. AJ, 130, 1212, which is incorporated herein by reference in its entirety. For a 3.67 m telescope such as the AEOS facility on Maui, this results in the ability to resolve debris objects down to ˜10 cm in Low Earth Orbit (LEO) and down to ˜10 m in geostationary (GEO) orbits.

It is contemplated herein that a QI imager 1000 including a WR-PLWFS 100 as disclosed herein may enable a new paradigm for sub-diffraction-limited imaging of space debris through the atmosphere without requiring adaptive optics. Unlike bulk optic mode-sorting schemes, systems and methods disclosed herein offer extremely high efficiencies and operate over large bandwidths—all without additional mechanisms to actively maintain alignment or specially-designed thermally-stabilized passive mounts. Further, a QI imager 1000 as disclosed herein may incorporate three key innovations: (i) photonic lantern spatial mode sorters with spatial and spectral diversity (see e.g., FIGS. 1A-1B), (ii) atmospheric blur removal enabled by mode/wavelength resolution, and (iii) transfer matrix and machine learning QI image reconstruction techniques.

Debris objects in orbit produce a wavelength-dependent source function due to solar illumination which we aim to reproduce from observational data. However, for debris separations or structure on scales smaller than the telescope diffraction limit, the image will have overlapping PSFs. Furthermore, for ground-based observations, the atmosphere produces strong phase variations which degrade the PSF by a factor of >30 typically at visible wavelengths, and which change on timescales of ˜1-10 ms (100-1000 Hz). Thus, classical systems are initially at a factor of ˜100 away from the necessary resolution, with rapidly evolving aberrations—a problem previously considered to be intractable. However, a QI imager 1000 with a WR-PLWFS 100 may enable new solutions to this problem which can in fact approach the quantum resolution limit via mode-demultiplexing sensors.

The difficulty of implementing the mode demultiplexing technologies required for sub-diffraction-limited space debris imaging arises from the highly multimode nature of the light being collected by the telescope. This demands high efficiency mode sorting devices supporting ˜1000 spatial modes with outputs that can be easily interfaced to single-mode fibers. A QI imager 1000 with a WR-PLWFS 100 includes photonic lanterns 102 which combine wave intensity and phase shifts in the spatial dimension to achieve such mode sorting. They consist of a smooth continuous 3-D waveguide transition which implements spatial transformations. The WR-PLWFS 100 thus accepts a multimode wavefront/image and converts it into an array of spatially separated single mode beams at high (>90%) optical efficiency. The WR-PLWFS 100 performs mode mapping equivalent to a transfer matrix operation from the multimode fiber modal basis to a basis consisting of an array of Gaussian beams. This transformation projects the phase/amplitude morphology of the incident light onto a linear combination of modes at the multimode input of the photonic lanterns 102. These in turn map to unique intensity patterns at the single-mode output waveguides 108. Thus, the WR-PLWFS 100 enables measurements of the distribution of intensities among the output waveguides 108 to reconstruct the incoming optical field via QI image retrieval algorithms.

In some embodiments, the photonic lanterns 102 are fabricated by fusing and tapering different fibers and glass capillaries together, producing photonic lanterns 102 that move from a multimode fiber input to an output array of isolated single-mode output fibers (e.g., output waveguides 108). The all-fiber construction allows us to build mode multiplexers engaging >1000s of modes with losses <1 dB over blue to near-infrared wavelengths simultaneously.

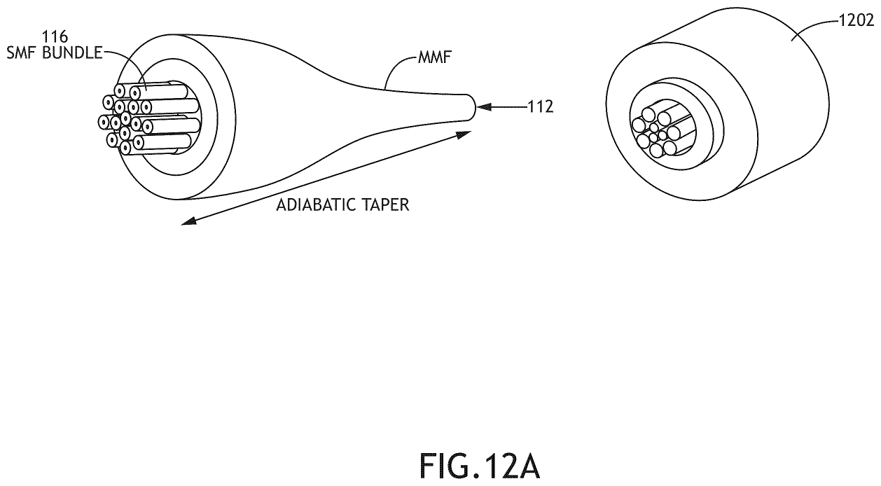

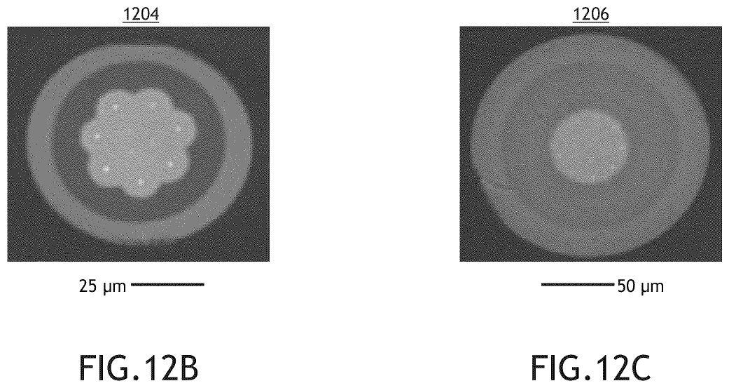

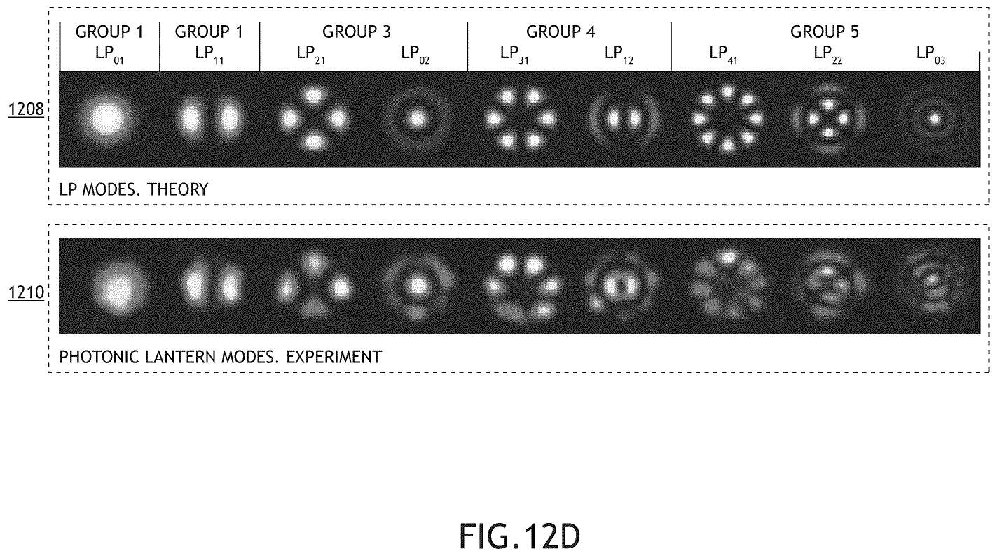

FIGS. 12A-12D depicts the construction and performance of fiber-based photonic lanterns 102, in accordance with one or more embodiments of the present disclosure. FIG. 12A is a schematic of a 15-port photonic lantern 102, in accordance with one or more embodiments of the present disclosure. FIG. 12B is a schematic of a capillary 1202 used to fabricate a 10-port photonic lantern 102, in accordance with one or more embodiments of the present disclosure. FIG. 12C includes a microscope image 1204 of 10-channel photonic lantern 102 and a microscope image 1206 of a 15-channel photonic lantern 102 at input ends 106, in accordance with one or more embodiments of the present disclosure. FIG. 12D includes theoretically expected (panel 1208) and experimentally measured (panel 1210) modal intensity, in accordance with one or more embodiments of the present disclosure.

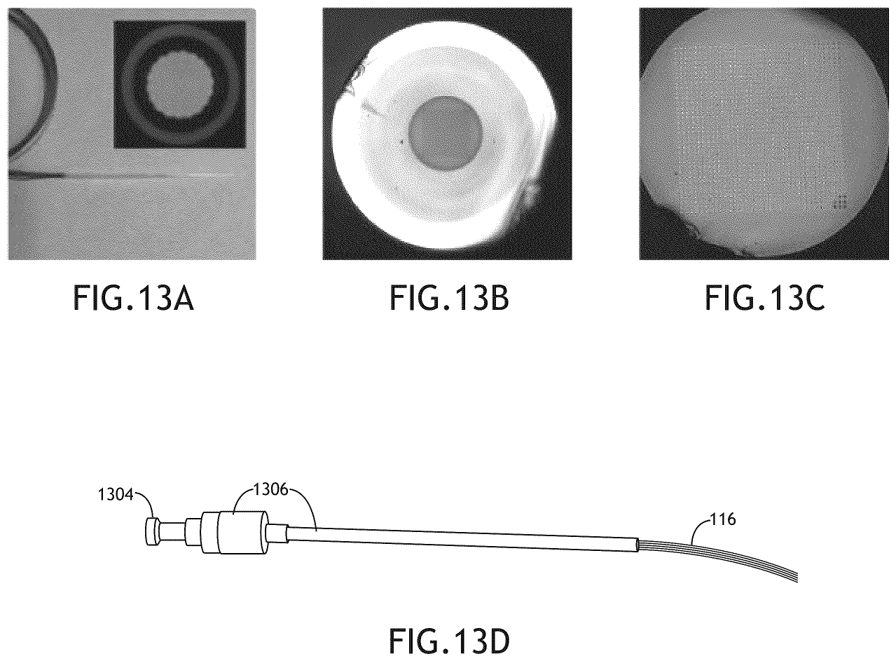

FIGS. 13A-13D depicts fabricated photonic lantern 102 mode multiplexers, in accordance with one or more embodiments of the present disclosure. FIG. 13A is an image of a 37-fiber photonic lantern, where the inset 1302 is a cross-sectional micrograph of the input multimode core, in accordance with one or more embodiments of the present disclosure. FIG. 13B is an image of a fabricated photonic lantern supporting 1156 spatial modes using the 34×34 core fiber, in accordance with one or more embodiments of the present disclosure. FIG. 13C is a magnified image of the 34×34 core from FIG. 13B, in accordance with one or more embodiments of the present disclosure. FIG. 13D is simplified perspective view a packaged and connectorized photonic lantern 102, in accordance with one or more embodiments of the present disclosure. In particular, FIG. 13D depicts an input end with a cap 1304, exterior packaging components 1306, and the output fibers 116.

To remove time-dependent atmospheric blur, a QI imager 1000 eschews adaptive optics and instead uses the intrinsic spectral diversity of the limiting resolution factors (λ/D for diffraction, ˜λ/r₀ for atmospheric turbulence) to break the degeneracy between these aberrating processes. Specifically, the Fried parameter r₀ scales as λ^{6/5}, so the atmospheric turbulence resolution changes only weakly with wavelength as λ^{-1/5} (and with the opposite trend of the DL, λ¹). This fact has been commonly exploited by astronomy for decades to achieve diffraction-limited imaging. Similarly, the spectral diversity provided by the WR-PLWFS 100 may be exploited to first solve for the atmospheric phase variations (near-constant in λ, but rapidly varying in time) to effectively “freeze” the residual modal information due to the source function and diffraction. This allows implementation of QI image retrieval algorithms linked to machine learning code to reconstruct the sub-diffraction-limited image. Importantly, this may be achieved without splitting the light between “sensing” and “science” channels, so that all the light is available for imaging.

Referring again to FIG. 11, operation of the QI imager 1000 is described in greater detail. The imaging sub-system 1002 telescope points to and tracks the debris target (the objects 1006), which are simultaneously imaged through a system of two photonic lanterns 102 in broadband light. The photonic lanterns 102 are judiciously designed to map the collected image into two distinct modal bases. This allows full reconstruction of the incoming optical field (amplitude and phase) unambiguously via an inverse mapping algorithm. In some embodiments, each photonic lantern 102 outputs the light through at least 1000 single mode fibers with their ends arranged in a square array. The light then passes through the spectrometer 114 to produce an array of separated mode spectra on the detector 120. The spectrometer 114 may be, but is not required to be, a relatively low-resolution (R=λ/Δλ=200) spectrograph with a collimator, dispersing prism (e.g., the dispersive element 118), camera, and high-speed CMOS detector 120. The modal spectra may then be read out at frame rates of ˜500 Hz (up to 1 kHz, as needed) and used to provide the full modal phase and amplitude versus wavelength as described above. In this way, the image may be reconstructed (e.g., by the controller 124) with resolution approaching the Cramer-Rao Lower Bound quantum limit.

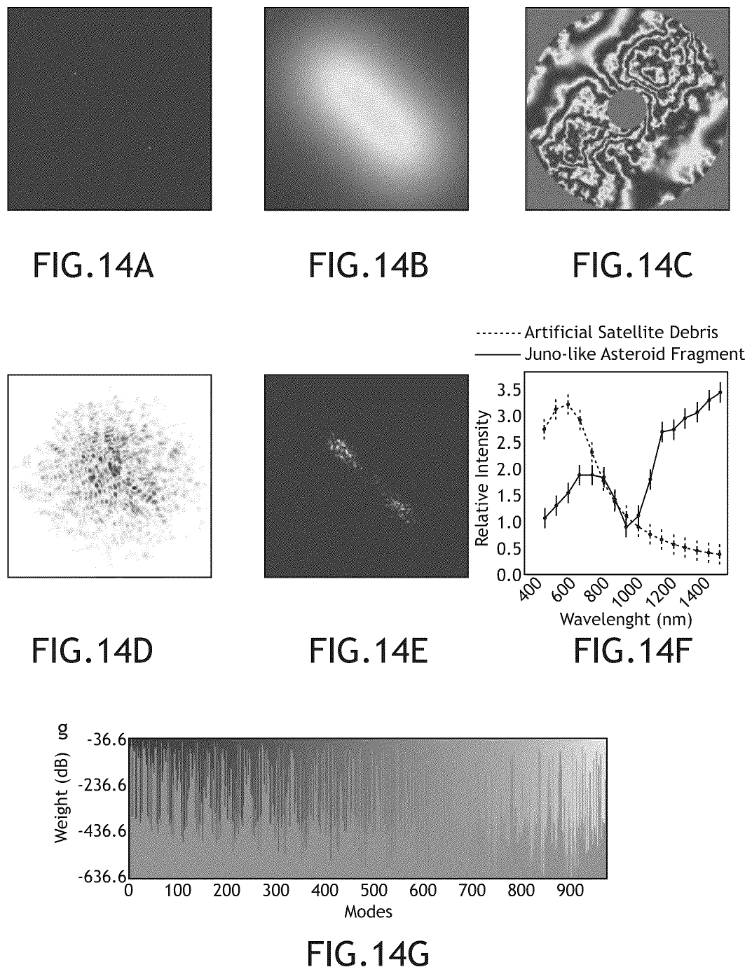

FIGS. 14A-14G includes plots depicting simulated performance of a QI imager 1000, in accordance with one or more embodiments of the present disclosure. FIG. 14A is an image of a simulated simple sub-diffraction-limited object source function comprised of two small (modeled as point-like) pieces separated by 5 cm at an altitude of 300 km separated by ˜0.5× the Rayleigh criterion on a 3.7-m telescope at visible wavelength and illuminated by the Sun with 30% albedo (broadband averaged), in accordance with one or more embodiments of the present disclosure. For the purposes of the simulation, one object is assumed to be an asteroid fragment with a Juno-like spectrum, while the other has a modified solar spectrum expected from artificial satellite albedo. FIG. 14B is an image of a diffraction-limited light distribution of these object sources from FIG. 14A under these conditions, in accordance with one or more embodiments of the present disclosure. FIG. 14C depicts simulated observed light distribution at the telescope based on time-variable phase aberrations introduced at the telescope pupil by atmospheric turbulence with a Kolmogorov power spectrum and r₀=10 cm, in accordance with one or more embodiments of the present disclosure. FIG. 14D includes a simulation of the full modal measurement versus wavelength provided by the QI imager 1000, in accordance with one or more embodiments of the present disclosure. FIG. 14E is a simulated image (wavelength-stacked) after application of the reconstruction techniques described previously herein that includes simulated spectral detector illumination, in accordance with one or more embodiments of the present disclosure. It is further noted that the QI imager 1000 captures the intrinsic spectral diversity in the targets and demonstrates the ability to distinguish between natural and artificial sources in LEO/GEO using the systems and methods disclosed herein. FIG. 14F is a plot of the spectral intensity of the two diverse objects generated using the simulated QI imager 1000, in accordance with one or more embodiments of the present disclosure. FIG. 14G is a plot of the modal decomposition derived from FIG. 14D and used to generate the data for FIGS. 14E-14F, in accordance with one or more embodiments of the present disclosure.

In some embodiments, QI-based image reconstruction may be performed using the following steps. First, the WR-PLWFS 100 may provide N modal intensities per photonic lantern 102 (e.g., using two photonic lanterns 102 as shown in FIG. 11) at W discrete wavelengths. This provides 2N×W measurements suitable for recovering the amplitude (Aₘ(λ)) and phase (ϕₘ(λ)) for each of the N modes per wavelength for the W discrete wavelengths. The WR-PLWFS 100 may then generate corrected amplitude (Aₘ^{corr}(λ)) and phase (ϕₘ^{corr}(λ)) information that at least partially removes the impact of atmospheric turbulence. In this way, the QI imager 1000 may solve for the atmospheric phase variations that are nearly constant across wavelengths but vary rapidly in time to effectively “freeze” the residual modal information due to the source function and diffraction. For example, the corrected amplitude and phase information may be generated by recomposing the turbulent image field E (x, y, λ) at the near field via a transfer matrix, extracting phase in the far field (ϕ(u, v, λ)), fit a wavelength dependence curve at each position (u, v) associated with atmospheric turbulence, and calculating a transfer of ϕₐₜₘ(u, v, λ) to ϕₘ(λ) to provide turbulence-corrected modes. Here E (x, y, λ) is the electric field, x and y are the spatial coordinates at the input of the photonic lantern, u and v are the spatial coordinates at the far field (pupil) location.

The controller 1008 may then apply a modal reconstruction algorithm to generate W source functions S(α, β, λ), where S is the source intensity at the angular locations a, B as a function of wavelength λ. Generally speaking, these reconstructions make use of both phase and amplitude information (as opposed to traditional imaging which simply relies on intensity) to develop solutions for S which are consistent with the measured field. In this way, the controller 1008 may generate a turbulence-corrected image.

Put another way, the controller 1008 may generate an image (e.g., of one or more objects) based on a wavelength-resolved modal composition of input light by solving for phase variations for a particular timeframe; constructing a turbulence-corrected image based on the phase variations; and constructing the image of the one or more objects based on the wavelength-resolved modal decomposition and the turbulence-corrected image.

One can then use reinforcement machine learning techniques to link these source functions over wavelength using the wavelength dependence of diffraction and the wavelength dependence of the source function emission as a constraint to refine these to S′(α, β, λ). The result of such an approach is a 3D data cube of source function versus angle-on-sky and wavelength at a resolution below the diffraction limit.

It is contemplated herein that this may serve as a transformative technology enabling new capabilities spanning across multiple sensing domains, enabling us to meet the critical needs of debris imaging and characterization. In particular, the intrinsic spectral diversity provided by the WR-PLWFS 100 naturally separates non-degeneracies in the source function of targets, providing important insights into composition/structural differences. This stands in strong contrast to broadband or bandpass devices which suffer from spectral confusion of general unknown source spectral features and/or limited spectral throughput and sensitivity. Although not explicitly shown, a QI imager 1000 may include a WR-PLWFS 100 with four photonic lanterns 102 in some embodiments together with polarization-analyzing bulk optics to provide linear polarization measurements with improved sensitivity for target structures with polarization diversity. Such polarization features should be commonly encountered for sub-diffraction-limited space debris due to scattering-induced polarization of the incoming sunlight off the differing shapes/orientations of the sub-structure components.

Referring more generally again to FIG. 10, additional application areas for a QI imager 1000 are now described in greater detail, in accordance with one or more embodiments of the present disclosure.

In some embodiments, the QI imager 1000 is configured as a space-based platform suitable for imaging Earth. In this configuration, the QI imager 1000 may provide atmospheric turbulence correction and sub-diffraction-limited imaging described above (e.g., with respect to FIG. 11). The broadband wavelength-resolved mode sensing provided by this configuration may enable the determination of the atmospheric turbulence impacts for arbitrary scenes, as opposed to current approaches which require/assume a point-like reference for wavefront metrology. This may provide extremely high-resolution hyperspectral imaging of ground targets through the atmosphere.

In some embodiments, a QI imager 1000 further includes adaptive optics to correct for turbulence (e.g., provide a turbulence-corrected image). Such a configuration may be suitable for sub-diffraction-limited imaging for space situational awareness either from the ground with adaptive optics or from space. In either case, the telescope system feeding the device (e.g., the imaging sub-system 1002) would provide diffraction-limited PSFs to the WR-PLWFS 100. This would obviate the need for turbulence correction from the WR-PLWFS 100 (and the controller 124), allowing lower-noise sub-diffraction-limited imaging as described above.

In some embodiments, a QI imager 1000 is configured for microscopic imaging. In this configuration, the imaging sub-system 1002 may include a microscope.

For example, a QI imager 1000 may include an objective lens to capture light from a sample and a lenslet array, where each lenslet in the lenslet array reimages an image plane of the sample (or a portion thereof) onto separate photonic lantern 102. For instance, the lenslet array may take the place of the beamsplitter 122 in FIG. 11. Such a QI imager 1000 may then include one or more spectrometers 114 to capture the spectra from the various output waveguides 108 of the photonic lanterns 102. In a general sense, the QI imager 1000 may include a lenslet array with any number of lenslets, along with any corresponding number of photonic lanterns 102. As an illustration, a QI imager 1000 may include a 30×30 lenslet array with a 100-micron pitch, corresponding to 12 microns at the sample plane of the microscope. Further, each lenslet in this configuration may reimage the field (or a portion thereof) to a 105-mode photonic lantern 102 with an 18-micron core diameter.

It is contemplated herein that such a configuration may enable sub-diffraction-limit fluorescence microscopic imaging. Such a hyperspectral approach enabled by the WR-PLWFS 100 may provide responses to multiple fluorescent tags simultaneously, but with resolution that meets or exceeds confocal microscopes.

As another example, a QI imager 1000 may be configured for super-resolution or lightsheet microscopy require carefully controlled illumination wavefronts. This configuration of a QI imager 1000 would eliminate the need for highly-constrained and expensive illumination systems, while achieving similar or better resolution and providing the advantages of hyperspectral response. In this approach, a broadband short-wavelength light source would illuminate the target field, exciting fluorescent tags (up to 10 or more simultaneously). The light would then be collected by the microscope objective (e.g., the imaging sub-system 1002) and focused onto a WR-PLWFS 100. This sensor would then provide full phase/amplitude information of the wavefront modes across the field of view. As with atmospheric turbulence, the distinct wavelength dependence of diffraction effects allows the WR-PLWFS 100 to disentangle those effects from the intrinsic source function and propagation effects through the target medium (e.g., cytoplasm, bioengineered liquid-like solid suspension, etc.). With this information, the same or similar techniques described above can reconstruct images to well below the classical diffraction limit. Furthermore, the wavelength-resolved source function could then be used to distinguish between the large number of fluorescent tags, even though their emission functions partially overlap. This in turn enables dynamical tracking of complex biological activities in live cell/tissue studies.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A sensor comprising:
one or more photonic lanterns, each of the one or more photonic lanterns including a waveguide structure with an input waveguide at an input end and two or more output waveguides at an output end, wherein the two or more output waveguides of each of the one or more photonic lanterns are optically decoupled, wherein a distribution of intensities of light exiting the two or more output waveguides of each of the one or more photonic lanterns corresponds to a modal decomposition of input light coupled into the input waveguide of a corresponding one of the one or more photonic lanterns; and
one or more spectrometers coupled to the two or more output waveguides of the one or more photonic lanterns to provide a wavelength-resolved modal decomposition of the input light.

2. The sensor of claim 1, further comprising:
a controller communicatively coupled to the one or more spectrometers, the controller including one or more processors configured to execute program instructions causing the one or more processors to:
determine wavelength-resolved measurements of at least one of an amplitude or a phase associated with modes of the input light.

3. The sensor of claim 1, wherein the one or more photonic lanterns comprise two photonic lanterns, wherein base modes associated with the modal decomposition of each of the two photonic lanterns are different, wherein the sensor further comprises a beamsplitter to receive the input light and direct portions of the input light to the input waveguides of the two photonic lanterns.

4. The sensor of claim 1, wherein the one or more photonic lanterns comprise a single photonic lantern.

5. The sensor of claim 4, further comprising:
a controller communicatively coupled to the one or more spectrometers, the controller including one or more processors configured to execute program instructions causing the one or more processors to:
determine wavelength-resolved measurements of at least one of amplitudes or phases associated with modes of the input light.

6. The sensor of claim 5, wherein determining the wavelength-resolved measurements of at least one of the amplitudes and the phases associated with the modes of the input light comprises:
determining the wavelength-resolved measurements of at least one of the amplitudes and the phases associated with the modes of the input light using a machine learning algorithm.

7. The sensor of claim 6, wherein the machine learning algorithm is trained on wavelength-resolved modal decompositions associated with a plurality of configurations of the input light with known values of at least one of amplitudes or phases of associated modes.

8. The sensor of claim 1, wherein the one or more spectrometers comprise a single spectrometer with a single two-dimensional detector, wherein the sensor further comprises:
two or more optical fibers coupled with the two or more output waveguides of the one or more photonic lanterns, wherein output ends of the two or more optical fibers are arranged in a linear distribution along a first direction at an input of the single spectrometer, wherein the single spectrometer includes a dispersive element to disperse the light from the two or more optical fibers along a second direction orthogonal to the first direction.

9. The sensor of claim 1, wherein the waveguide structure of at least one of the one or more photonic lanterns comprises a fiber waveguide structure.

10. An imaging system comprising:
an imaging sub-system including optics configured to image one or more objects onto a field plane;
a sensor at the field plane comprising:
one or more photonic lanterns, each of the one or more photonic lanterns including a waveguide structure with an input waveguide at an input end and two or more output waveguides at an output end, wherein the two or more output waveguides of each of the one or more photonic lanterns are optically decoupled, wherein a distribution of intensities of light exiting the two or more output waveguides of each of the one or more photonic lanterns corresponds to a modal decomposition of input light coupled into the input waveguide of a corresponding one of the one or more photonic lanterns; and
one or more spectrometers coupled to the two or more output waveguides of the one or more photonic lanterns to provide a wavelength-resolved modal decomposition of the input light; and
a controller communicatively coupled to the one or more spectrometers, the controller including one or more processors configured to execute program instructions causing the one or more processors to:
receive the wavelength-resolved modal decomposition of the input light; and
generate an image of the one or more objects based on the wavelength-resolved modal decomposition of the input light.

11. The imaging system of claim 10, wherein generating the image of the one or more objects based on the wavelength-resolved modal decomposition of the input light comprises:
solving for phase variations for a particular timeframe;
constructing a turbulence-corrected image based on the phase variations; and
constructing the image of the one or more objects based on the wavelength-resolved modal decomposition and the turbulence-corrected image.

12. The imaging system of claim 10, wherein the imaging sub-system further comprises adaptive optics configured provide that the image is a turbulence-corrected image.

13. The imaging system of claim 10, wherein the image has a resolution below a diffraction limit of the imaging sub-system.

14. The imaging system of claim 10, wherein the imaging sub-system comprises:
a telescope.

15. The imaging system of claim 10, wherein the imaging sub-system comprises:
a microscope.

16. The imaging system of claim 10, further comprising:
a controller communicatively coupled to the one or more spectrometers, the controller including one or more processors configured to execute program instructions causing the one or more processors to:
determine wavelength-resolved measurements of at least one of an amplitude or a phase associated with modes of the input light.

17. The imaging system of claim 10, wherein the one or more photonic lanterns comprise two photonic lanterns, wherein base modes associated with the wavelength-resolved modal decompositions of the two photonic lanterns are different, wherein the imaging system further comprises at least one of a beamsplitter or a lenslet array to receive the input light and direct portions of the input light to the input waveguides of the two photonic lanterns.

18. The imaging system of claim 10, wherein the one or more photonic lanterns comprise a single photonic lantern.

19. The imaging system of claim 18, further comprising:
a controller communicatively coupled to the one or more spectrometers, the controller including one or more processors configured to execute program instructions causing the one or more processors to:
determine wavelength-resolved measurements of at least one of amplitudes and phases associated with modes of the input light.

20. The imaging system of claim 19, wherein determining the wavelength-resolved measurements of at least one of amplitudes and phases associated with the modes of the input light comprises:
determining the wavelength-resolved measurements of at least one of amplitudes or phases associated with the modes of the input light using a machine learning algorithm.

21. The imaging system of claim 20, wherein the machine learning algorithm is trained on wavelength-resolved modal decompositions associated with a plurality of configurations of the input light with known values of at least one of amplitudes or phases of associated modes.

22. The imaging system of claim 10, wherein the one or more spectrometers comprise a single spectrometer with a single two-dimensional detector, wherein the imaging system further comprises:
two or more optical fibers coupled with the two or more output waveguides of the one or more photonic lanterns, wherein output ends of the two or more optical fibers are arranged in a linear distribution along a first direction at an input of the single spectrometer, wherein the single spectrometer includes a dispersive element to disperse the light from the two or more optical fibers along a second direction orthogonal to the first direction.

23. The imaging system of claim 10, wherein the waveguide structure of at least one of the one or more photonic lanterns comprises a fiber waveguide structure.
